(19) United States
(12) Patent Application Publication
(10) Pub. No.: US 2012/0066879 A1
(43) Pub. Date: Mar. 22, 2012

(54) ASSEMBLY FACILITATION APPARATUS AND METHOD

(76) Inventor: BERND P. DAESCHNER, Fairview, PA (US)

(21) Appl. No.: 12/885,613

(22) Filed: Sep. 20, 2010

(51) Int. Cl. B23P 19/04; B23P 11/02; B25B 27/14; B23P 19/10; B25B 11/00

(52) U.S. Cl. 29/407.05; 29/281.1; 29/720; 29/800; 29/281.4; 29/428; 29/447

(57) ABSTRACT

An assembly facilitation apparatus for assembling and seating bearings on a gearbox pinion. The apparatus includes a bearing cup support for holding a bearing for assembly onto a pinion and an arm operatively connected to the bearing cup support. The arm is configured to engage the pinion and seat a bearing on a first portion of the pinion by moving the pinion axially in a first direction relative to the bearing.

### FIELD OF THE INVENTION

Embodiments of the invention relate generally to an assembly facilitation apparatus and method and, in particular, to an apparatus for assembling gearbox components.

### BACKGROUND OF THE INVENTION

Wind turbine systems are conventionally known. Such systems generally include a rotor head to which wind turbine blades are attached, a main shaft coupled to the rotor head so as to integrally rotate with the rotor head, a gear box coupled to the main shaft that rotates by means of wind power received by the wind turbine blades, and an electrical generator driven by an output shaft from the gear box. The gearbox and generator are typically housed in a nacelle mounted atop a tower.

In use, the wind turbine blades transform wind energy into a rotational torque or force that drives the electrical generator. The gearbox is used to step up the inherently slow rotation, high torque of the turbine rotor to a much higher rotation and lower torque for input into the electrical generator. In this manner, the gearbox provides a high speed, low torque output to the generator suitable for the production of electricity.

Conventional gear boxes for use with wind turbines can weigh several tons and typically contain numerous stages and gears to achieve an overall gear ratio from 40:1 to over 100:1, depending on the size of the turbine. As will be readily appreciated, assembling such large and heavy components found in wind turbine gearboxes presents several problems. In particular, assembling and seating bearings on a gearbox pinion and conducting end play dimensional checks have typically been done at separate stations in the overall assembly process. Accordingly, assembling and seating bearings on a high-speed gearbox pinion and measuring end play has proven to be time consuming and costly. As such, there is a need for an assembly apparatus that facilitates both the assembly of gearbox components, such as a bearing on a pinion, as well as the measurement of end play of the assembled components on the same apparatus, rather than at separate assembly substations.

### BRIEF DESCRIPTION OF THE INVENTION

According to one embodiment of the present invention, an assembly apparatus includes a bearing cup support configured to hold a bearing or bearing race for assembly onto a pinion, and an arm operatively connected to the bearing cup support. The arm is configured to engage the pinion, and is operable to seat a bearing on the pinion by moving the pinion axially in a first direction relative to the bearing.

According to another embodiment of the present invention, an apparatus for assembling and seating bearings on a gearbox pinion includes an upper support surface for receiving a pinion and supporting a bearing housing assembly mounted to the pinion, a lower support surface configured to hold a bearing for assembly onto the pinion, and a movable gantry operatively connected to the upper support structure and being operable to seat a bearing on the pinion by moving the pinion axially in a first direction relative to the bearing. The lower support structure includes a gear lock to prevent rotation of the pinion during assembly.

Yet another embodiment of the inventive apparatus is a method of assembling a gearbox. The method includes placing a bearing in a bearing cup support, lowering a pinion through the bearing cup support and into engagement with the bearing, and moving the pinion axially in a first direction relative to the bearing to seat the bearing on a first portion of the pinion.

### BRIEF DESCRIPTION OF THE DRAWINGS

The present invention will be better understood from reading the following description of non-limiting embodiments, with reference to the attached drawings, wherein below:

FIG. 1 is an isometric view of a frame, upper support surface and lower support surface of an assembly apparatus in accordance with an embodiment of the inventive apparatus for assembling and seating bearings on a gearbox pinion.

FIG. 2 is a side elevational view of the frame, upper support surface and lower support surface of the assembly apparatus of FIG. 1.

FIG. 3 is an isometric view of the upper support surface and gantry of the assembly apparatus in accordance with an embodiment of the inventive apparatus for assembling and seating bearings on a gearbox pinion.

FIG. 4 is a side elevational view of the upper support surface and gantry of the assembly apparatus of FIG. 3.

FIG. 5 is a top plan view of the assembly apparatus in accordance with an embodiment of the inventive apparatus for assembling and seating bearings on a gearbox pinion.

FIG. 6 is an isometric view of the assembly apparatus in operation and showing the assembly of a pinion, bearing and bearing housing assembly in accordance with the present invention.

FIG. 7 is a top plan view of a bearing cup and heating mechanism of the assembly apparatus of FIG. 1.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts.

As described in detail below, an embodiment of the present invention provides an apparatus for assembling and seating bearings (or bearing race) on a high speed gearbox pinion 90. Embodiments of the inventive apparatus include beneficial alignment and end play configuring features.

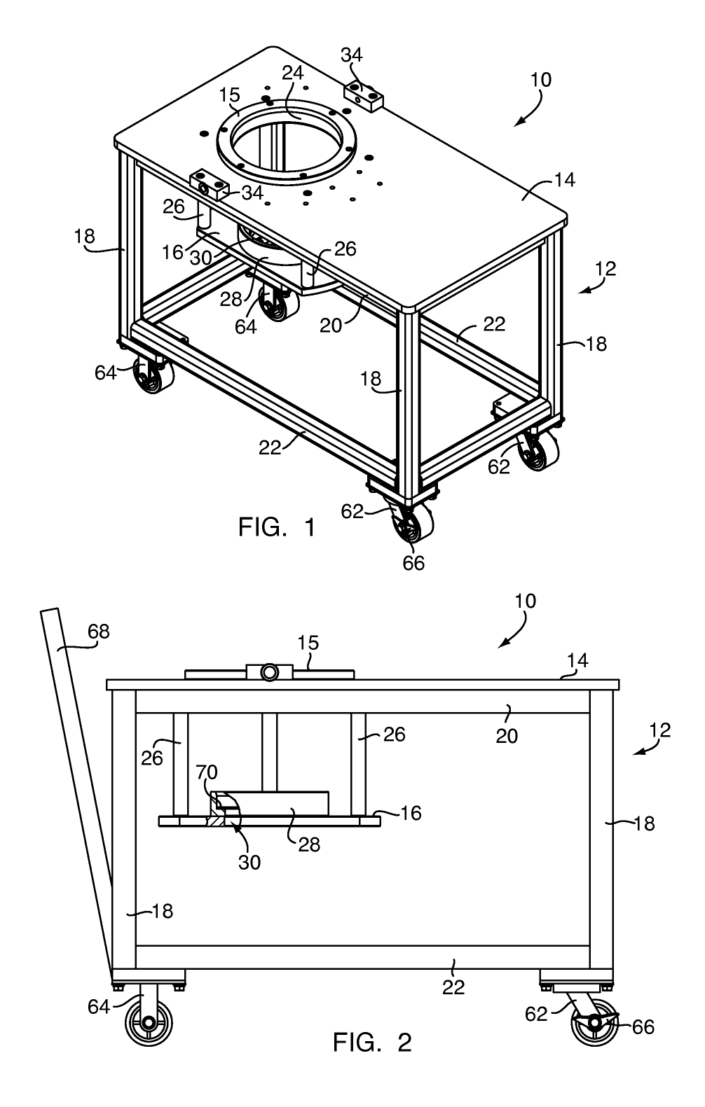

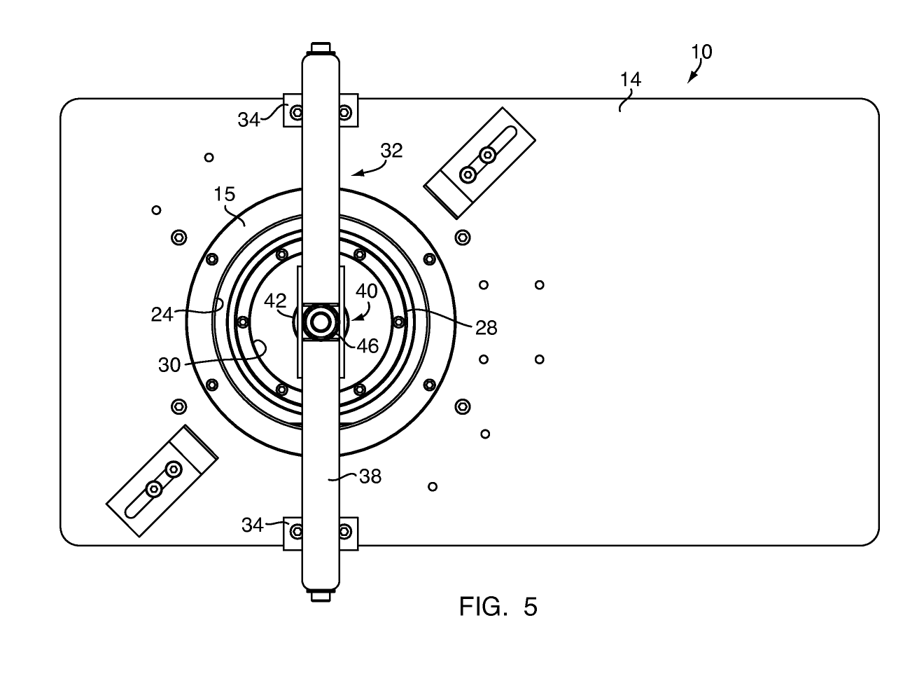

Referring generally to FIGS. 1-7, an embodiment of the assembly apparatus 10 of the present invention generally takes the form of a cart and includes a frame 12, an upper support surface 14 and a lower support surface 16. The frame 12 is formed from a plurality of metal rails, including a plurality of vertical rails 18, horizontal upper rails 20 and horizontal lower rails 22, arranged so as to form a generally rectangular box and suitable to support the weight of the upper support surface 14, lower support surface 16, a high speed pinion 90, and other components. The frame 12 may also include bracing components and/or cross-members for added frame stability, support and safety.

The upper support surface 14 is a substantially planar metal plate that rests on and is secured to the upper rails 20, and has a length and width at least coextensive with that of the frame 12. A generally circular aperture 24 is provided in the upper support surface 14 for accommodating the high speed pinion 90, as discussed in detail below. An annular register plate 15 is secured to an upper surface of the upper support surface 14 and is coaxial with the aperture. The register plate 15 facilitates alignment of a bearing housing assembly, as discussed below.

The lower support surface 16 is, like the upper support surface 14, a substantially planar metal plate. The lower support surface 16 lies in a plane parallel to the upper support surface 14 and is located below the upper support surface 14 (and intermediate the upper rails 20 and lower rails 22 of the frame 12). The lower support surface 16 has a surface area that is less than that of the upper support surface 14 and is spaced therefrom by a plurality of spacer posts 26 (cup carrier components). A plurality of socket head cap screws extending thought cart holes in the upper support surface 14 connect the upper and lower support surfaces 14,16 to the spacer posts, although other means of attachment are possible. For example, the spacer posts may be welded or integrally formed with the upper and lower support surfaces 14,16 or electromagnetic couplers can be used to temporarily hold a bearing cup 28, as discussed below.

The lower support surface 16 is positioned directly below the aperture 24 in the upper support surface 14. A bearing cup 28 having a circular recess for holding a bearing or bearing race for assembly onto the pinion 90 is connected to an upper surface of the lower support surface 16. The bearing cup 28 is substantially coaxial with aperture 24 in the upper support surface 16 for facilitating alignment and assembly of the bearing onto the pinion 90, as discussed below. A plurality of socket head cap screws secure the bearing cup 28 to the lower support surface 16, although other means of attachment such as welding may also be used to secure the bearing cup 28. A second aperture 30 having a dimension less than that of the bearing support 28 is provided through the bearing support cup 28 and the lower support surface 16 for allowing at least a portion of the pinion 90 to extend through.

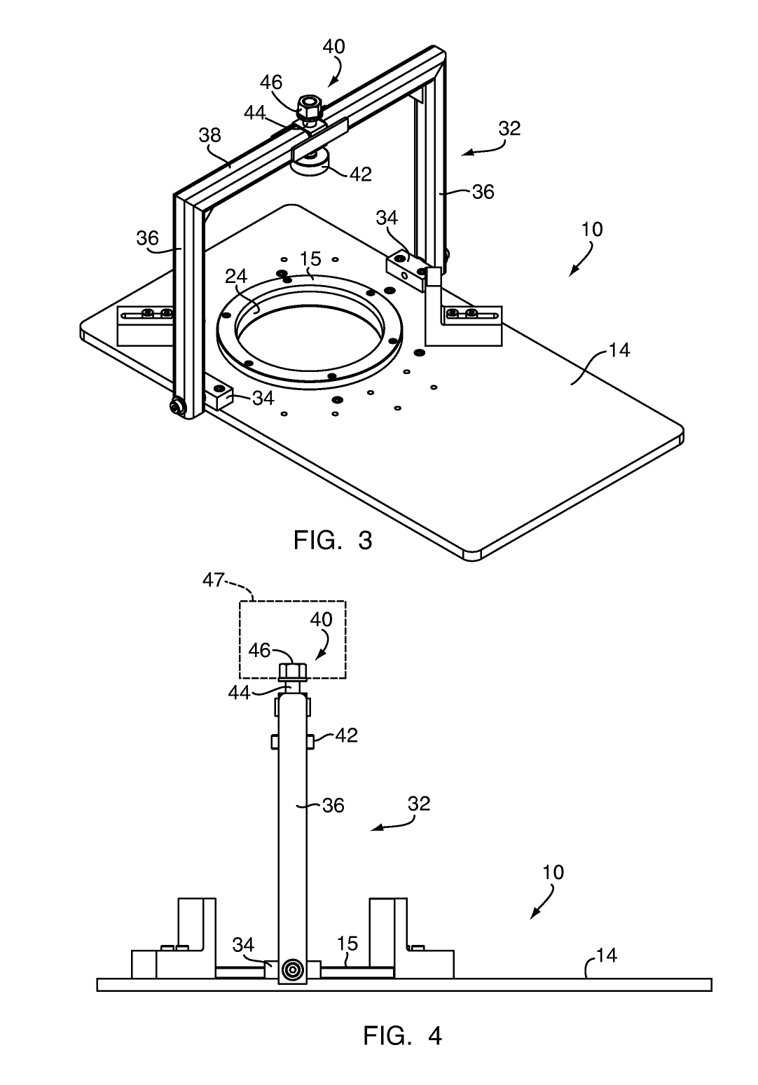

The assembly apparatus 10 further includes a swing arm or gantry 32 connected to the upper support surface 14 by a pair of tap blocks 34. In particular, the tap blocks 34 are secured to the upper support surface 14 using a plurality of socket head cap screws or the like, and the swing arm 32 is secured to the tap blocks 34 using shoulder bolts and flat washers. The swing arm 32 comprises a rigid frame having two vertical portions 36 and a horizontal portion 38 and is pivotable about the shoulder bolts from an upright position to a clearance position to permit access to aperture 24 such that a pinion 90 and bearing housing assembly 100 can be placed on the apparatus 10, as discussed below. The horizontal portion 36 of the swing arm 32 is spaced above from the upper support surface 14 and spans across the aperture 24 in the upper support surface 14 when in its upright position, as shown in FIGS. 1 and 3.

The gantry or swing arm 32 is configured to engage the pinion and includes a seating mechanism 40 that is operable to seat a bearing on a first portion of the pinion 90 by moving the pinion axially downward relative to the bearing. The seating mechanism 40 comprises a pusher block 42 for contacting an upper end of the pinion, a pusher stud 44 secured to the pusher block 42 and extending through the horizontal portion 36 of the swing arm 32, and a flange nut 46 threaded on the pusher stud 44 and located above the horizontal portion 36 of the swing arm 32. Rotation of flange nut 46 in a first direction about pusher stud 44 causes pusher block 42 to move downwards towards aperture 24, and rotation of flange nut 46 in a second direction opposite the first direction causes pusher block 42 to move upwards away from aperture 24. Alternatively, a motor may be coupled to the flange nut 46 to automatically rotate the flange nut 46. The seating mechanism 40 also includes a dial indicator at the top thereof for measuring end play between the pinion 90 and the bearing housing assembly 100, as discussed below.

The assembly apparatus 10 also includes a locking mechanism 48 that is operable to prevent rotation of the pinion 90 while the bearing or bearing race is being seated. The locking mechanism is positioned between upper support surface 14 and lower support surface 16 and may be secured to either the upper support surface 14 or lower support surface 16. The locking mechanism 48 engages the pinion 90 so as to prevent rotation thereof during downwards movement of the pinion 90 when the flange nut 46 (and pusher block 42 and pusher stud 44) is torqued down.

The assembly apparatus 10 further includes a clamping mechanism 50 that is selectively operable to prevent movement of the bearing housing assembly relative to the frame 12 so that end play between the pinion 90 and the bearing housing assembly 100 may be measured by means known in the art. As shown in FIG. 6, the clamping mechanism generally comprises at least one vertical post 52 having a horizontal extension arm 54 for accommodating a threaded clamp 56. Upon rotation of the clamp 56, the clamp 56 is advanced towards a cap of the housing assembly to exert a downward force thereon. The clamping mechanism 50 may also include a retaining block 58 for engaging an underside of the flange of the bearing housing assembly to restrain any movement thereof.

As best shown in FIG. 6, the assembly apparatus 10 also includes a lifting mechanism 60 that is operable to move the pinion 90 axially upwards to measure the axial end play between the pinion 90 and the bearing housing assembly 100. As shown therein, the lifting mechanism 60 is supported by the lower rails 22 of the frame and includes a vertical shaft in registration or axial alignment with the pinion through the second aperture 30. In an embodiment, the lifting mechanism 60 is located proximate the lower support surface 16, i.e., the lifting mechanism 60 is close enough to the lower support surface 16 so that when the mechanism 60 is actuated it can effect an upwards axial movement of the pinion 90 by applying a force to a lower end thereof. The lifting mechanism 60 may be a jack, such as a bottle jack, or a pneumatic or other type of motorized ram. In the case where motorized rams are employed, the rams are configured to automatically calculate shim pack need/parameters. An in-ram sensor 61 can be used for linear distance measurement.

In addition to the above, the assembly apparatus 10 may be fitted with a plurality of wheels and/or swivel casters for supporting the assembly apparatus 10 and for facilitating movement thereof. The wheels and or/swivel casters may be attached to an underside of the frame 12 by hex bolts, washers and nuts, although other attachment means known in the art may also be used. As shown in FIGS. 1 and 2, the apparatus has two swivel casters 62 and two rigid casters 64. A wheel locking mechanism or braking mechanism 66 may be coupled to at least one of the plurality of wheels or swivel casters to enable a user to lock the apparatus 10 in place so that it will not roll or move from its set location. As with the swivel casters, the braking mechanism may be fixedly attached to the underside of the frame by hex bolts, washers and nuts, although other attachment means known in the art may also be used.

The assembly apparatus 10 also has an attachment mechanism, such as a tongue hitch 68 that may be, for example, pivotally attached to the apparatus. The mechanism allows the apparatus 10 to be attached to motive power or to another assembly apparatus or cart.

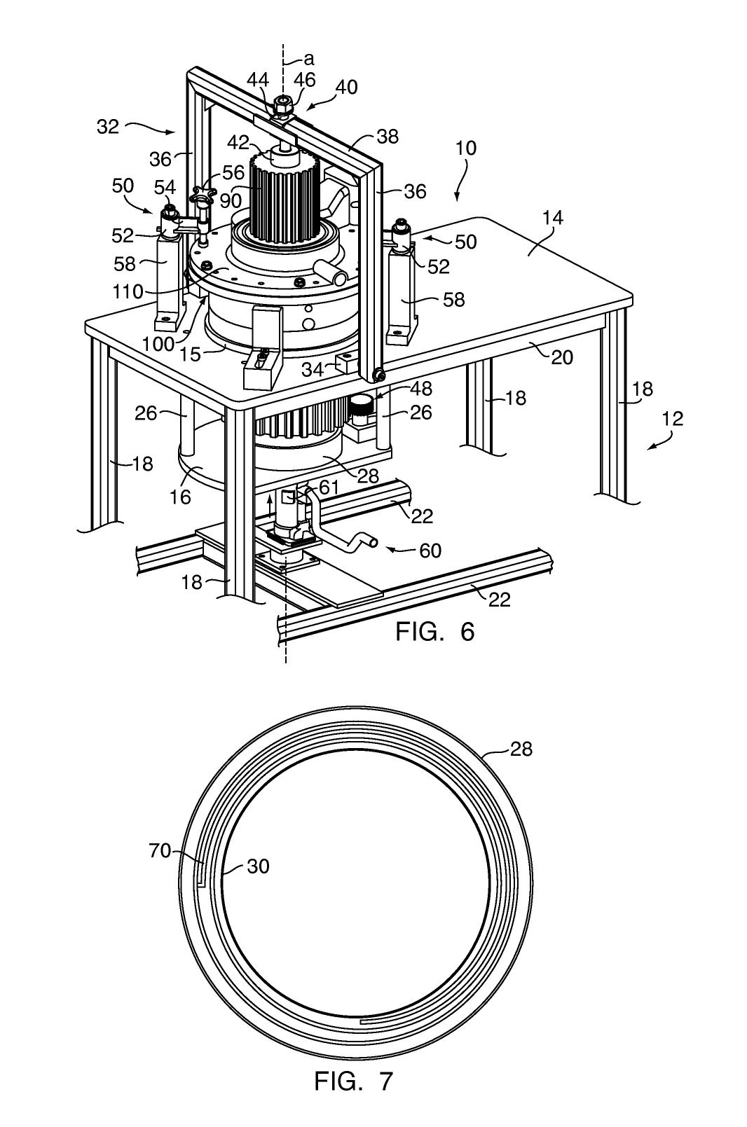

In another embodiment of the present invention, the apparatus 10 may also include a mechanism to modify the temperature of the bearing while it is on the apparatus 10. In particular, the apparatus 10 may include an induction heater 70, or the like, mounted to the frame 12, underside of the upper support surface 14 or lower support surface 16 and in close proximity to a bearing in the bearing cup 28. As shown in FIG. 7 the heater may be a generally flat induction heater mounted inside the bearing cup support 28. The heater 70 can be used to raise the temperature of the bearing to expand the bearing to facilitate seating of the bearing about the pinion. In addition, a chiller or cooler may be mounted to the apparatus 10 in close proximity to the bearing cup support 28 to more precisely control the temperature of the bearing or the bearing race.

In yet another embodiment, the assembly apparatus 10 includes sensors which may communicate with an overall tracking system that can correlate field problems and end play check measurements to detect and/or predict failures. In addition, robotics may be employed to move the swing arm 32 and/or engage the clamping mechanism 50 on the bearing housing assembly cap and bearing cup support to provide a full or semi-automated device.

In operation, a bearing or bearing race is heated to a predetermined temperature and is placed in the bearing cup support 28. Alternatively, the bearing may be heated to a predetermined temperature subsequent to placing it in the bearing support cup 28 by heater 68. Swing arm or gantry 32 is then rotated about the shoulder bolts of the tap blocks 34 to a clearance position to allow a pinion 90 having an axis, a, to be lowered through aperture 24, aperture 30, and bearing cup support 28 and into engagement with the bearing. The swing arm 32 is then rotated back to its upright, assembly position as shown in FIG. 4 such that the pusher block 42 and pusher stud 44 are positioned in axial alignment with the pinion 90. Locking mechanism 48 is then actuated to lock the pinion 90 in place and to prevent it from rotating prior to seating the bearing. The pinion 90 is then moved axially in a first direction (downwards) relative to the bearing to seat the bearing on a first portion of the pinion. Movement of the pinion downwards to seat the bearing (bearing race) on the pinion is effectuated by seating mechanism 40, as discussed above. In particular, upon manual or automatic rotation of the flange nut 46 (such as by signaling a motor 47 to rotate the flange nut 46), pusher stud 44 extends pusher block 42 until it is in contact with an upper end of the pinion. Upon further rotation of the flange nut 46, pusher block 42 exerts a force upon the upper end of the pinion 90, thereby pushing the pinion downwards and into engagement with the bearing.

In addition to the above, a bearing housing assembly may be lowered onto upper support surface 14 and into engagement with and secured to a second, upper portion of the pinion. Annular register plate 15 ensures proper alignment of the bearing housing assembly 100 on the upper support surface 14 about aperture 24. The bearing housing assembly 100 and cap 102 is then clamped in place on the upper support surface 14 to prevent movement of the bearing housing assembly 100 and to facilitate the measurement of end play.

To measure the end play between the pinion 90 and the bearing housing assembly 100, lifting mechanism 60 pushes up on a lower end of the pinion to move the pinion axially in a second direction (opposite the first direction in which the pinion was moved to seat the bearing). As discussed above, the lifting mechanism 60 may be a jack or motorized ram. In the case where the lifting mechanism 60 is a motorized ram, an operator may signal a motor to move the pinion axially in the second direction. If the measured amount of end play does not meet a predetermined value, or fall within predetermined limits, the amount of actual end play may be adjusted by means known in the art until the end play between the pinion and the bearing housing assembly 100 meets such predetermined value or falls within such predetermined limits.

An embodiment of the inventive apparatus may include an upper support surface configured to receive a pinion and support a bearing housing assembly mounted on the pinion, a lower support surface configured to hold a bearing for assembly onto the pinion, a gear lock to prevent rotation of the pinion, a moveable gantry connected to the upper support surface and being operable to seat a bearing on the pinion by moving the pinion axially in a first direction relative to the bearing, a clamp assembly on the upper support surface and a lifting assembly proximate the lower support surface and operable to move the pinion in a second direction opposite the first direction to measure end play between the pinion and the bearing housing assembly. In certain circumstances, this embodiment may omit the above-referenced clamp assembly and gear lock without departing from the spirit and scope of invention.

In other embodiments, the apparatus may include, in addition to the above, a locking mechanism operable to prevent rotation of the opinion while the bearing is being seated and a mechanism to modify the temperature of the bearing while the bearing is on the apparatus. Moreover, a plurality of wheels may be included to support the apparatus, a braking mechanism to lock the wheels in place, and an attachment mechanism allowing the apparatus to be attached to motive power or another assembly apparatus.

In yet other embodiments, the lifting mechanism may be a jack or a motorized ram. The mechanism to modify the temperature of the bearing may be an induction heater located proximate the bearing. It may also be desirable to include a plurality of frame members and support rails to strengthen the support the apparatus.

In an embodiment, the gantry or swing arm may be coupled to a motor that may be signaled to move the pinion axially in the first direction. A sensor may be included on the lifting mechanism to measure linear distance movement thereof.

In addition to the above, an embodiment of the present invention contemplates a method of assembling a gearbox. The method includes the steps of placing a bearing in a bearing cup support, lowering a pinion through the bearing cup support and into engagement with the bearing, and moving the pinion axially in a first direction relative to the bearing to seat the bearing on a first portion of the pinion. The method may additionally include the step or steps of locking the pinion in place to prevent its rotation prior to moving the pinion axially in the first direction, modifying the temperature of the bearing in the bearing cup support and signaling a motor to move the pinion axially in the first direction.

In yet another embodiment, the method may further include the steps of securing a bearing housing assembly to a second portion of the pinion and moving the pinion axially in a second direction to measure end play between the pinion and the bearing housing assembly. In the case of this embodiment, the method optionally include clamping the bearing housing assembly to prevent movement of the bearing housing assembly and modifying the measured amount of end play so that it meets a predetermined value.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled.

In the appended claims, the terms “including” and “in which” are used as the plain-English equivalents of the respective terms “comprising” and “wherein.” Moreover, in the following claims, the terms “first,” “second,” “third,” “upper,” “lower,” “bottom,” “top,” “up,” “down,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person skilled in the art to practice the embodiments of invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described embodiments, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. An assembly apparatus, the apparatus comprising:
a bearing cup support configured to hold a bearing for assembly onto a pinion, the pinion defining an axis;
an arm operatively connected to the bearing cup support and configured to engage the pinion; and
wherein the arm is operable to seat the bearing on a first portion of the pinion by moving the pinion axially in a first direction relative to the bearing.

2. The assembly apparatus of claim 1, further comprising:
a locking mechanism that is operable to prevent rotation of the pinion while the bearing is being seated.

3. The assembly apparatus of claim 1, further comprising:
a frame operatively connected to the bearing cup support and arm; and
wherein the frame is configured to receive the pinion as well as a bearing housing assembly mounted to a second portion of the pinion.

4. The assembly apparatus of claim 3, wherein the frame includes a clamping mechanism that is selectively operable to prevent movement of the bearing housing assembly relative to the frame so that end play between the pinion and the bearing housing assembly may be measured.

5. The assembly apparatus of claim 4, further comprising:
a lifting mechanism that is operable to move the pinion axially in a second direction opposite the first direction to measure the end play between the pinion and the bearing housing assembly.

6. The assembly apparatus of claim 5, wherein the lifting mechanism is a jack.

7. The assembly apparatus of claim 5, wherein the lifting mechanism is a motorized ram.

8. The assembly apparatus of claim 1, further comprising a mechanism to modify a temperature of the bearing while the bearing is on the apparatus.

9. The assembly apparatus of claim 1, further comprising:
a frame operatively connected to the bearing cup support and arm; and
a plurality of wheels operatively connected to the frame and a braking mechanism coupled to at least one of the plurality of wheels.

10. The assembly apparatus of claim 1, further comprising an attachment mechanism allowing the apparatus to be attached to motive power or another assembly apparatus.

11. An apparatus for assembling and seating bearings on a gearbox pinion, the apparatus comprising:
an upper support surface configured to receive a pinion and support a bearing housing assembly mounted on the pinion, the pinion defining an axis;
a lower support surface configured to hold a bearing for assembly onto the pinion, the lower support surface having a gear lock to prevent rotation of the pinion; and
a movable gantry operatively connected to the upper support surface, the gantry being operable to seat the bearing on the pinion by moving the pinion axially in a first direction relative to the bearing.

12. The apparatus of claim 11, further comprising:
a clamp assembly on the upper support surface, the clamp assembly being operable to prevent axial movement of the bearing housing assembly relative to the upper support surface; and
a lifting assembly proximate the lower support surface, the lifting assembly being operable to move the pinion in a second direction opposite the first direction to measure end play between the pinion and the bearing housing assembly.

13. A method of assembling a gearbox, comprising:
placing a bearing in a bearing cup support;
lowering a pinion through the bearing cup support and into engagement with the bearing, the pinion defining an axis; and
moving the pinion axially in a first direction relative to the bearing to seat the bearing on a first portion of the pinion.

14. The method as defined by claim 13, further comprising locking the pinion in place to prevent its rotation prior to moving the pinion axially in the first direction.

15. The method as defined by claim 13, further comprising heating the bearing to a predetermined temperature prior to placing the bearing in the bearing cup support.

16. The method as defined in claim 13, further comprising modifying a temperature of the bearing in the bearing cup support.

17. The method as defined in claim 13, further comprising signaling a motor to move the pinion axially in the first direction.

18. The method as defined by claim 13, further comprising:
securing a bearing housing assembly to a second portion of the pinion; and
moving the pinion axially in a second direction to measure end play between the pinion and the bearing housing assembly.

19. The method as defined by claim 18, further comprising clamping the bearing housing assembly to prevent movement of the bearing housing assembly and facilitate the measurement of end play.

20. The method as defined by claim 18, further comprising modifying an amount of the end play between the pinion and the bearing housing assembly so that it meets a predetermined value.

21. The method as defined in claim 18, further comprising signaling a motor to move the pinion axially in the second direction.
